(19) United States
(12) Patent Application Publication
(10) Pub. No.: US 2003/0223167 A1
(43) Pub. Date: Dec. 4, 2003

(54) Distributed bus differential relay system

(76) Inventor: Eric A. Udren, Pittsburgh, PA (US)

Correspondence Address: Martin J. Moran, Cutler Hammer, Technology & Quality Center, 170 Industry Dr., RIDC Park West, Pittsburgh, PA, 15275-1032, US

(21) Appl. No.: 09/747,345

(22) Filed: Dec. 22, 2000

(51) Int. Cl. H02H 3/00

(52) U.S. Cl. 361/65

(57) ABSTRACT

A distributed bus differential relay system has a separate differential relay element at each feeder location to trip the associated circuit breaker in response to a fault in the protected bus. The only conductors between feeders form a set of leads connecting current transformers in each of the feeders in parallel. Preferably, the current transformer in each feeder also serves as the current transformer for the associated circuit breaker and the differential relay element is incorporated into the overcurrent relay or trip unit of the circuit breaker which is implemented by a microprocessor. Compliance voltage across the cts is limited by a varistor or saturating reactor which is protected from overheating by a time delayed shorting device.

### BACKGROUND OF THE INVENTION

1. Field of the Invention

This invention relates to a differential relay system for protecting a bus in an electric power distribution system. More particularly, it relates to such a differential relay system which is distributed and integrated with the trip units of circuit breakers which protect the bus.

2. Background Information

In a typical electric power distribution system, a bus serves a number of feeders, one or more of which supply power to the bus while the remainder are connected to loads which can draw power from the bus. Each of the feeders, ingoing and outgoing, is connected to the bus through a circuit breaker.

In a radial distribution system, that is one in which all of the power comes from one source at a time, it is common to coordinate the trip responses of the circuit breakers in the feeder lines by incorporating a delay into the response of the trip unit in the circuit breaker in the feeder through which power is supplied to the bus. This allows a circuit breaker in a feeder in which a fault occurs to respond first and isolate the fault without interrupting power flow through the bus to the remainding feeders. If the fault is on the bus, the circuit breaker in the feeder line supplying power will trip after the delay period. While this can be effective, it allows the current for a fault on the bus to build to a high value before the breaker trips.

In some applications, a zone interlock technique is used to speed up tripping for bus faults. Circuit breakers on the outgoing feeders generate an interlock signal if they see a current above a fault threshold. This interlock signal is passed to the circuit breakers higher up in the hierarchy and prevents their tripping yet allows the interlocked circuit breakers to initiate their timing so that if the circuit breaker lower down on the hierarchy does not trip within a predetermined period of time, the higher up circuit breaker can be ready to trip. Such interlock signals use a plus 5Vdc interlocking signal. The interlocking technique is efficient in instances where this logic signal is adequately robust. In some installations, it is not.

In any event, for really reliable and fast bus protection, many users install a separate bus differential relay. Current transformers for measuring current in each of the feeder lines are all wired in parallel to a common relay. Under normal conditions, with no fault on the bus, the current flowing into the bus will equal the current flowing out so that the relay sees a resultant zero current. However, if the fault is on the bus, there will be an imbalance which triggers the differential relay and trips all of the breakers on the bus. This tripping is instantaneous, and not dependent upon inter-relay communications.

The most popular bus protection technique is the high impedance scheme. In this arrangement, the current transformers (cts) in the feeders are connected in parallel across a voltage measuring unit which is a plunger or cylinder unit in existing electromechanical relays. All of the cts have the same secondary to primary turns ratio. As mentioned, during normal loading, the currents into the bus equal the currents leaving it so that the summation of the secondary currents from the cts is approximately zero and the voltage unit does not pick up. During a fault of moderate current external to the bus zone, the currents increase, but still add up to approximately zero and the voltage unit still does not pick up. The voltage setting in the unit becomes important because the relay should not trip due to ct ratio errors at higher currents. During an internal bus zone fault, the ct currents in each phase add up to the fault current in that phase. This secondary fault current has no where to flow. The source cts are all pushing with their fault compliance voltage capability, and all the exciting branch impedances are high. The ct secondary voltage builds to very high values, hundreds or even thousands of volts, as the ct in the source feeders try to make the external circuit comply with their current sources. This high voltage operates the voltage unit and trips all the bus breakers to isolate the fault.

This high impedance differential relay, as well as the alternative percentage differential relay for protecting a bus, requires the collected current signals from all of the feeder cts on the bus. The relay has a single trip contact which operates a multi-trip auxiliary relay. This multi-trip auxiliary relay has many contacts, a group of which trip each of the breakers and others of which block the breaker closing circuits. This arrangement requires an external source to operate the high energy trip solenoids of the circuit breakers.

It has become common in low voltage circuit breakers to use low energy trip devices such as the flux shunt trip device which can be operated by power drawn from the circuit breaker current measuring ct. As mentioned, the presently available differential relays require external power to provide a high energy tripping signal.

There is a need, therefore, for improved protection of a distribution bus, and more particularly for an improved differential relay scheme for protecting a distribution bus.

One of the needs of such an improved differential relay is a reduction in the extensive wiring required in the presently available relay schemes.

Another need is for an improved differential relay in which additional feeders may be easily and simply added to an installation.

There is yet another need for an improved differential relay which does not require an external power source.

There is still another need for an improved differential bus relay which is capable of operating with a low energy circuit breaker trip mechanism.

There is a strong need for an improved differential bus relay which is simpler, cheaper, and easier to install and maintain.

### SUMMARY OF THE INVENTION

These needs and others are satisfied by the distributed bus differential relay system of the invention, which includes current transformers measuring current in each of the associated feeder lines and all connected in parallel by a set of leads. Individual differential relay elements associated with each of the circuit breakers in each of the feeder lines are connected to the set of leads connecting the current transformers in parallel. Each of these differential relay devices responds to voltage conditions on the set of leads created by a fault on the bus. With a fault on the bus, the current through the cts in the feeders connected to the source or sources will exceed the current leaving the bus through the remainder of the feeders. As this current will have no where to go, a compliance voltage will be developed which the individual differential relay elements will respond to by tripping the associated breaker. Preferably, an integrated function of this voltage is utilized to reduce the likelihood of spurious trips based upon transients or voltage spikes. As the differential relay function is distributed in each feeder line, only the set of leads connecting the current transformers is required, thereby eliminating the large number of leads needed in the prior art bus differential relay schemes between the single, central differential relay and the feeder breakers. As the typical distribution system is three-phase, the simplification of the wiring required is more pronounced.

Another significant advantage provided by the invention is realized when used with circuit breakers with low energy, such as flux transfer, trip devices. The energy available in the high voltage signal is sufficient to operate both the differential relay elements and the low energy trip devices in the circuit breakers so that no external power is required. In a most preferred form of the invention, a single current transformer in each feeder line serves as a current transformer for the differential relay element and also provides the current measurements for the overcurrent relay in the circuit breaker. In addition, the distributed differential relay function is preferably integrated with the overcurrent and short circuit functions of the associated circuit breaker such as, for instance, in a microprocessor based trip unit or overcurrent relay.

As the compliance voltage generated by a low impedance fault on the bus can become very large, the invention can include a voltage limiter connected across the set of leads connecting the current transformers in parallel. This current limiting device can be, for instance, a varistor or a saturating core reactor. In any event, this voltage limiting device provides a shunt for an excess of the unbalanced current when the voltage reaches a level above the operating voltage for the differential relay element. As prolonged operation of, for instance, the varistor, can lead to overheating and failure, a short circuit device shunts the voltage limiting device. This short circuit device becomes active only after a period of time sufficient for each of the circuit breaker overcurrent relays to respond to the fault on the bus. As the varistor is damaged by joule heating, the short circuit device may be made responsive to an integral of the voltage above a threshold value. This threshold value is at least a limiting value of the varistor. Preferably, a resistor is provided in series with the varistor so that the voltage responsive circuit in the shorting device responds more quickly to higher currents through the varistor.

It is therefore, an object of the invention to provide an improved bus differential relay, and in particular, to provide a distributed bus differential relay system.

A specific object of the invention is to reduce and simplify the wiring required in a bus differential relay system. More particularly, it is an object of the invention to provide a distributed bus differential relay system in which the differential relaying function can be integrated with the overcurrent relay function of the circuit breaker in the associated feeder line.

It is another object of the invention to provide a distributed bus differential relay system which does not require an external power source either to perform the relay function or to trip the circuit breaker.

It is yet another object of the invention to provide a distributed bus differential relay system which prevents excessive build-up of compliance voltage.

It is still another object of the invention to provide a distributed bus differential relay system which prevents overheating and failure of the devices limiting the compliance voltage.

### BRIEF DESCRIPTION OF THE DRAWINGS

A full understanding of the invention can be gained from the following description of the preferred embodiments when read in conjunction with the accompanying drawings in which:

FIG. 1 is a schematic single line diagram of a distributed bus differential relay system in accordance with the invention.

FIG. 2 is a schematic diagram illustrating in more detail a distributed bus differential relay which forms part of the system of FIG. 1.

FIG. 3 is a schematic wiring diagram illustrating application of the system to a three-phase distribution system.

### DESCRIPTION OF THE PREFERRED EMBODIMENTS

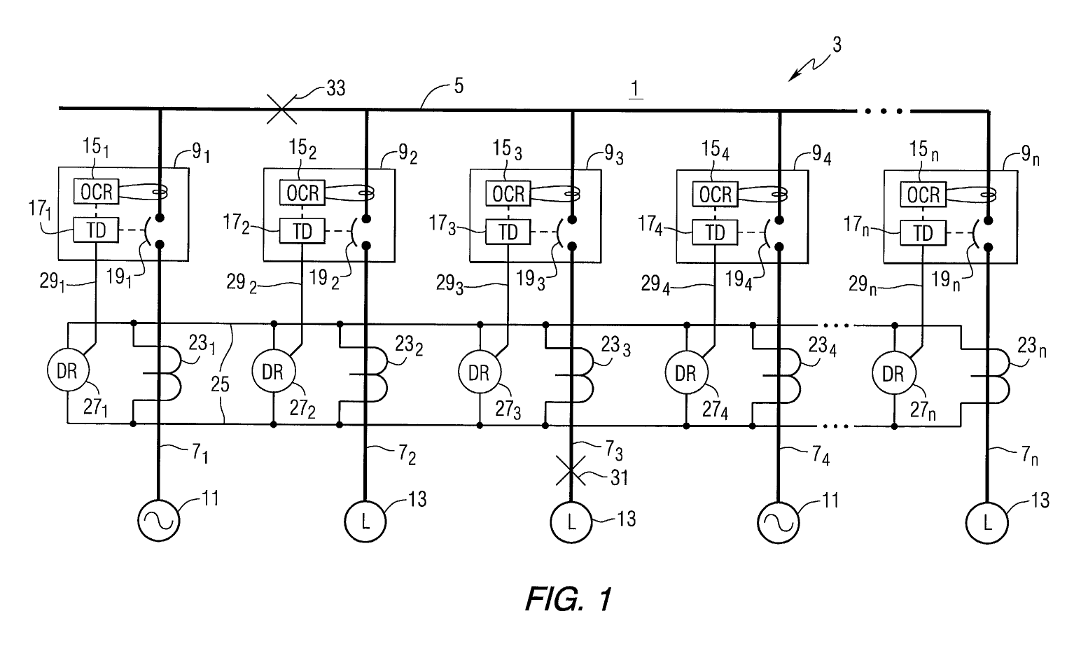

FIG. 1 illustrates in single line an electric power distribution system 1 to which the distributed bus differential relay system 3 of the invention has been applied. The distribution system 1 includes a bus 5 to which a number of feeder lines 71-7n are connected through an associated circuit breaker 91-9n. One or more of the feeders, such as feeders 71 and 74, are connected to sources of power 11 while the remaining feeders, 72, 73 and 7n in the example, are connected to deliver power to loads 13.

Each of the circuit breakers 91-9n has an overcurrent relay (OCR) 151-15n also known as a trip unit which responds to predetermined overcurrent and short circuit conditions in the associated feeder to actuate a trip device 171-17n which opens the main contact 191-19n of the breaker to disconnect the bus 5 from the associated feeder. In a preferred embodiment of the invention, the overcurrent relay 15 in each of the circuit breakers is implemented by a microprocessor. Also, in this preferred embodiment, the trip devices 17 are low energy trip devices, such as the well-known flux transfer or similar sensitive mechanism which responds to the low energy trip signal generated by the microprocessor based overcurrent relay.

The distributed bus differential relay system 3 includes a current transformer (ct) 231-23n which measures the current flowing in the associated feeder line. As is well known, these current transformers typically are formed by a toroidal coil through which the feeder line passes and serves as a one-turn primary winding. The coils which form the secondary windings of the ct 231-23n are all connected in parallel by a set of leads 25. Associated with each circuit breaker, and therefore each feeder line, is an individual differential relay element 271-27n. Each of the differential relay elements 271-27n responds to the voltage on the leads 25 and under circumstances to be described trips the associated trip device 171-17n through a trip lead 291-29n.

The turns ratios of all of the cts 231-23n are the same, so that under normal conditions with no faults on the bus 5, and therefore with the currents into the bus equal to the currents out of the bus, the sum of the currents generated by all of the cts 231-23n will be essentially zero. Under these conditions, the voltage on the leads 25 is ideally zero. Even with slight variations in the cts, the voltage on the leads 25 will be very low and the individual differential relay elements 271-27n can be set to be unresponsive to such low voltages.

Likewise, if a fault occurs in one of the feeders such as the fault 31 on the feeder 73 which is outside the protected bus zone (which is above the circuit breakers 15 in FIG. 1) the sum of the currents going into and out of the bus will still be zero and the differential relay elements 271-27n will not respond.

If, however, there is a fault such as 33 on the protected bus 5, the incoming and outgoing current to the bus as measured by the cts 231-23n will not balance. As the current through the individual current transformers is dictated by the current in the primary, i.e., in the associated feeder line, the error current has no path through which it can flow. As a result, a compliance voltage builds up on the leads 25. As this voltage appears across all of the differential relay elements 271-27n each responds and trips the associated circuit breaker 151-15n to disconnect the bus 5 from all of the feeders 71-7n.

The most difficult situation for a bus differential relay is where the external (feeder) fault 31 is a high current fault which occurs very close to the associated circuit breaker 15 so that there is very little impedance in the section of the feeder carrying the fault current. Under these circumstances, the associated current transformer 233 in the example can saturate resulting in an imbalance in the currents in the cts 231-23n even though the fault is outside of the bus protection zone. As the error current has no where to flow because the other cts will not accept the error current, the voltage across the leads 25, and therefore across the differential relay elements 23, rises. The situation is relieved somewhat by the fact that when the ct, such as 233 saturates, its impedance goes down to the resistance of the coil 231-23n, which reduces the voltage that appears across the leads 25. The differential relay elements, therefore, must be set so that they do not respond to this voltage which appears across the leads 25 in response to saturation of the associated current transformer.

Many of the advantages of the distributed bus differential relay system 3 of the invention can be appreciated from FIG. 1. It must be remembered that the figure is schematic and that in an actual installation the distances between the feeders would be typically substantially greater than the distance between the differential relay elements and the associated circuit breaker. Thus, the only wiring extending the substantial distance between circuit breakers is the set of leads 25. This greatly reduces the wiring required for a bus differential relay system. In addition, the system is modular so that if additional feeders are added, the associated ct 23 and differential relay element 27 need only be connected to the leads 25, which can easily be extended if necessary. The presence of the differential relay elements 27 at the associated circuit breaker has an additional advantage when the circuit breakers have low energy trip units. With the distributed differential relay element close to the associated trip unit, there is no long lead which would be susceptible to noise and, therefore, false tripping of the trip unit. Since high energy signals are not needed to actuate the trip devices, the energy generated by the compliance voltage resulting from a fault on the bus is easily sufficient to power all of the distributed differential relay elements and to actuate the associated low energy trip units.

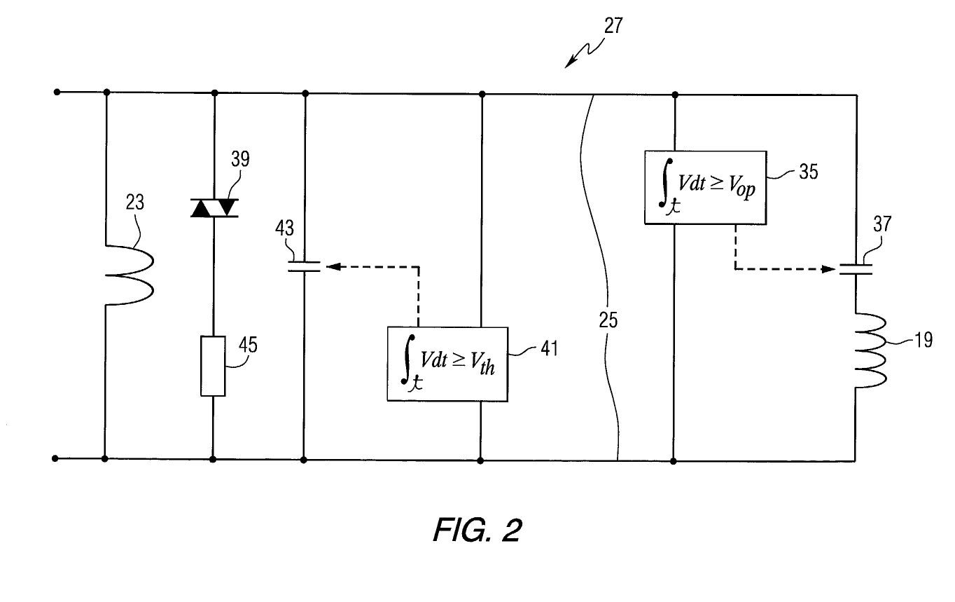

FIG. 2 illustrates in more detail the differential relay element 27 and its associated ct 23. The differential relay element 23 includes a voltage responsive device 35 connected across the leads 25. While the voltage responsive device 35 can respond to a voltage on the leads 25 above a predetermined operating level, preferably the device incorporates an integrating function which requires that the predetermined voltage persist for an interval sufficient to prevent false tripping in response to transients. When the predetermined integrated value is reached, the voltage responsive device 35 connects the low energy trip device 19 of the associate relay across the leads 25 through a switch or contacts 37. As previously mentioned, the error current generating the compliance voltage produces sufficient energy to actuate the trip device.

As explained above, the imbalance in the sum of the currents produced by the cts 23 when there is a fault on the bus can produce a very high voltage across the leads 25. This could lead to insulation breakdown and serious damage. Accordingly, a voltage limiting device 39 is placed across the leads 25. In the illustrated embodiment of the invention this voltage limiting device is a varistor. The varistor 39 is selected to have a breakover voltage which is above the operating voltage of the voltage responsive device 35, yet low enough to protect the wiring. When the breakover voltage of the varistor is exceeded, it shunts current thereby reducing the imbalance in currents and limits the voltage on the leads 25 to values under the insulation ratings of the wiring and the circuit devices. As an alternative, the voltage limiting device could be a saturating reactor which saturates from the high instantaneous voltage generated by the fault on the bus and drops to a low value of impedance a couple of milliseconds after each zero crossing.

The available energy from the cts 23 in response to a fault on the bus 5 is very high which could cause the varistor 39 rapidly overheat and fail. However, this problem threatens only for an internal bus fault for which the relay must trip. In order to protect the varistor 39, a shorting circuit 41 is provided across the leads 25. Preferably, this shorting circuit 41 responds to the integral of voltage above a threshold level to provide a response that is related to the joule heating of the varistor. In effect, this shorting circuit provides a time delay sufficient for the voltage responsive devices 35 associated with all the circuit breakers to respond. It then closes contacts or switch 43 which shorts the leads 25 and provides a by-pass path for current, thereby preventing failure of the varistor. A resistor 45 placed in series with the varistor 39, causes the shorting circuit 41 to respond more quickly to higher currents through the varistor. While a single voltage limiter 39 and shorting circuit 41 can be provided across the leads 25, for standardization of the modular differential relay elements 27, a varistor and shorting circuit can be included in each module. This also provides redundancy which assures safe operation.

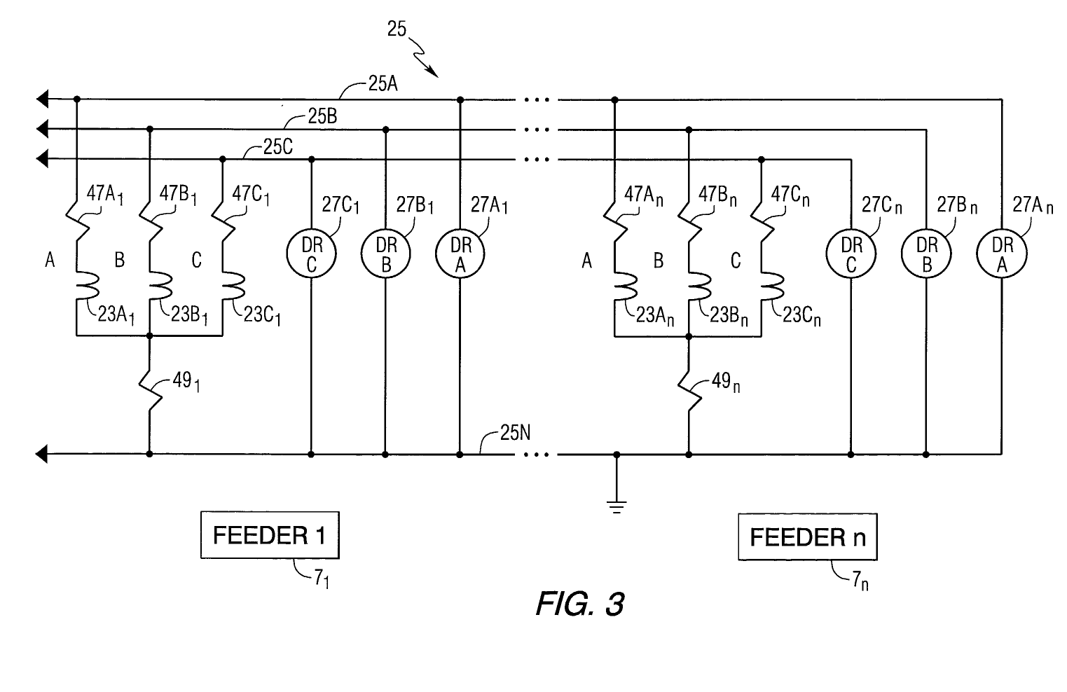

FIG. 3 illustrates the wiring for a three-phase system in which a connection is shared by the overcurrent relay of the circuit breaker and the distributed differential bus relay element in each feeder line. In the circuit of FIG. 3, the set of leads 25 include leads 25A, 25B and 25C leads for phases A, B and C and a common lead 25N. Separate current transformers 23A1, 23B1, 23C1-23An, 23Bn, 23Cn are connected between the respective phase leads 25A-25C and the lead 25N. Similarly, a differential relay element 27A, 27B, 27C-27An, 27Bn, 27Cn is connected between each of the phase leads and the neutral. The current measured by each of the cts also flows through the terminals 47A, 47B, 47C-47An, 47Bn, 47Cn of the overcurrent relay associated with each phase. Thus, the shared or common current transformer for each phase not only provides the current measurement for the differential relay element but also provides the current input for the overcurrent relay for providing instantaneous and delayed protection for each phase. The currents for all of the phases also passes through the terminals 491-49n of the associated overcurrent relay for providing a measurement for ground currents. Without a ground fault, the vector sum of the instantaneous phase currents is zero. With a ground fault, this sum will be non-zero and the overcurrent relay can trip the circuit breaker to provide ground fault protection in a known manner.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A distributed bus differential relay system for an electric power distribution system comprising a bus, a plurality of feeder lines including at least one feeder line supplying power to said bus and the remaining feeder lines connected to draw power from said bus, and a plurality of circuit breakers each connecting an associated one of said feeder lines to said bus, said relay system comprising:
a plurality of current transformers each measuring current in an associated feeder line;
a set of leads connecting said plurality of current transformers in parallel; and
a plurality of differential relay elements connected across said set of leads and associated with one of said circuit breakers for tripping the associated circuit breaker in response to predetermined voltage conditions across said set of leads.

2. The system of claim 1 wherein said differential relay elements include voltage responsive devices which trip the associated circuit breaker in response to a persistent voltage across said leads above a predetermined value.

3. The system of claim 1 wherein said bus and feeder lines are multi-phase, said current transformers comprise a current transformer associated with each phase of each feeder line, said set of leads comprises phase leads connecting said current transformers associated with each phase in parallel, and said differential relay elements comprise multi-phase differential relay elements associated with each circuit breaker and connected across each of said phase leads and responsive to predetermined voltage conditions across any of said phase leads to trip the associated circuit breaker.

4. The system of claim 1 wherein said circuit breakers have low energy trip devices and said differential relay elements are powered by the associated current transformer and generate a low energy trip signal which trips the low energy trip device of the associated circuit breaker.

5. The system of claim 4 wherein each circuit breaker has an overcurrent relay which actuates said low energy trip device in response to certain conditions of measured current and said current transformers associated with each feeder line provide measured current to the overcurrent relay of the associated circuit breaker.

6. The system of claim 5 wherein said differential relay element is incorporated into said overload relay of the associated circuit breaker.

7. The system of claim 6 wherein said overload relay is a microprocessor based overload relay.

8. The system of claim 1 wherein each circuit breaker includes an overcurrent relay which trips the circuit breaker in response to certain conditions of measured current and wherein said current transformers associated with each feeder line provide measured current to the overcurrent relay of the associated circuit breaker.

9. The system of claim 1 wherein said at least one of said differential relay elements includes a voltage limiting device connected to limit voltage across said set of leads to a preselected voltage.

10. The system of claim 9 wherein said at least one of said differential relay elements further includes a shorting device shorting said voltage limiting device after a period of time sufficient for said circuit breakers to be tripped in response to a fault on said bus.

11. The system of claim 9 wherein each of said differential relay elements includes a voltage limiting device.

12. The system of claim 11 wherein each of said differential relay elements includes a shorting device.

13. The system of claim 9 wherein said voltage limiting device comprises a varistor.

14. The system of claim 13 wherein said at least one differential relay element includes a shorting device shorting said varistor after a period of time sufficient for said circuit breakers to be tripped by said differential relay elements in response to a fault on said bus.

15. The system of claim 14 wherein said shorting device integrates with respect to time voltage on said leads above said preselected voltage.

16. The system of claim 15 including a resistor in series with said varistor across said set of leads.
